(19) United States
(12) Patent Application Publication
(10) Pub. No.: US 2005/0130528 A1
(43) Pub. Date: Jun. 16, 2005

(54) Web with smooth feel, bright appearance and durability

(76) Inventor: Chih-Hsin Wang, Taichung Hsien (TW)

Correspondence Address: Alan D. Kamrath;Rider Bennett, LLP, Suite 2000, 333 South Seventh Street, Minneapolis, MN, 55402, US

(21) Appl. No.: 10/736,046

(22) Filed: Dec. 15, 2003

(51) Int. Cl. B32B 27/12

(52) U.S. Cl. 442/149; 442/181

(57) ABSTRACT

A web with a smooth feel, a bright appearance and durability is disclosed here. The web includes a first fabric of nylon fibers, a second fabric of polyester fibers woven together with the first fabric of nylon fibers and a decorative layer attached to the second fabric. The decorative layer is easily attached to the second fabric by means of coating or heating.

### FIELD OF INVENTION

The present invention relates to a web with a smooth feel, a bright appearance and durability.

### BACKGROUND OF INVENTION

Referring to FIG. 4, there is shown a conventional band 30 that is often used together with a collar for a dog. The band 30 includes a fabric 31 woven of nylon fibers, a layer 32 of thermal glue and a decorative layer 33. The fabric 31 woven of nylon fibers provides strength and a smooth feel. The fabric 31 woven of nylon fibers however fails to provide a bright appearance. On the contrary, the decorative layer 33 provides a bright appearance. In practice, the decorative layer 33 cannot be attached to the fabric 31 woven of nylon fibers. The layer 32 of thermal glue is used to adhere the decorative layer 33 to the fabric 31 woven of nylon fibers. The thermal glue includes a low melting point. The layer 32 of thermal glue is often molten because of high temperatures in containers during transportation of the band 30. Hence, the decorative layer 33 is detached from the fabric 31 woven of nylon fibers. That is, the band 30 is ruined.

The present invention is therefore intended to obviate or at least alleviate the problems encountered in prior art.

### SUMMARY OF INVENTION

It is the primary objective of the present invention to provide a web with a smooth feel, a bright appearance and durability.

According to the present invention, a web includes a first fabric of nylon fibers, a second fabric of polyester fibers woven together with the first fabric of nylon fibers and a decorative layer attached to the second fabric.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a side view of a dog wearing a collar used together with a band according to the preferred embodiment of the present invention.

FIG. 2 is a top view of the band shown in FIG. 1.

FIG. 3 is a cross-sectional view of the band shown in FIG. 1.

FIG. 4 is a cross-sectional view of a conventional band that is often used together with a collar for a dog.

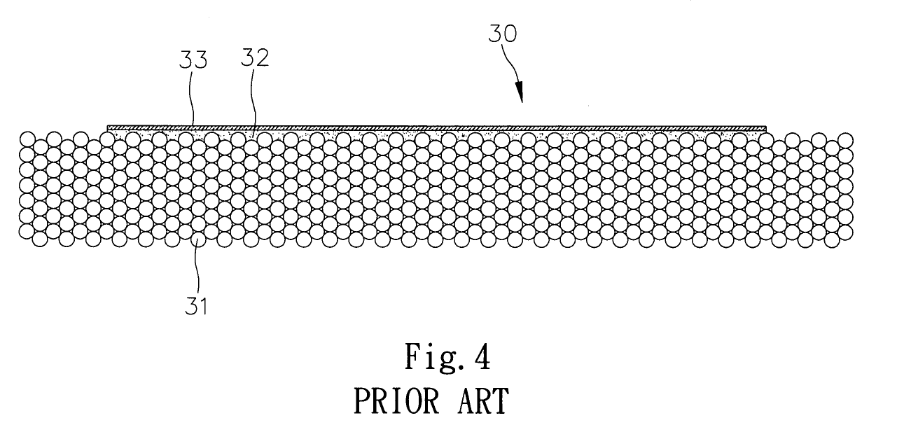

### DETAILED DESCRIPTION OF EMBODIMENTS

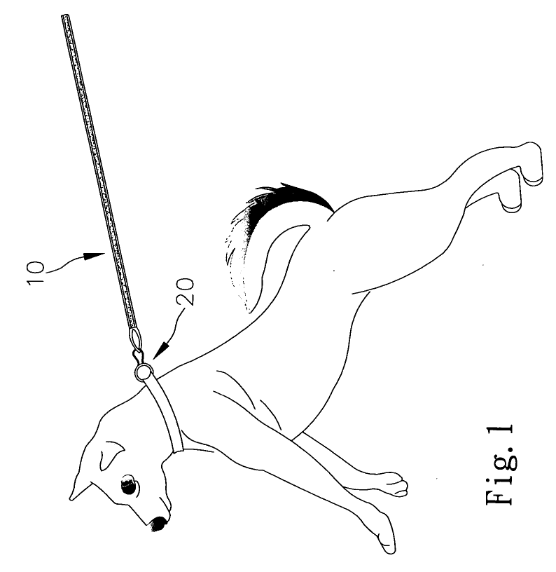

Referring to FIG. 1, a dog wears a collar 20 tied with a band 10 according to the preferred embodiment of the present invention.

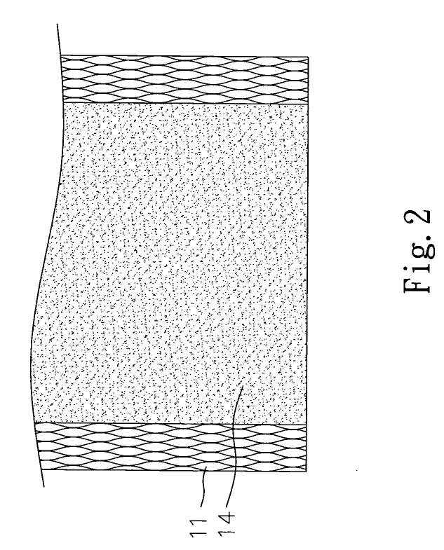

Referring to FIG. 2, a top view, the band 10 includes a fabric 11 woven of nylon fibers and two decorative strips 14 attached to the fabric 11 woven of nylon fibers in an indirect manner to be described. The fabric 11 woven of nylon fibers provides strength and a smooth feel. The decorative strips 14 provide a bright appearance.

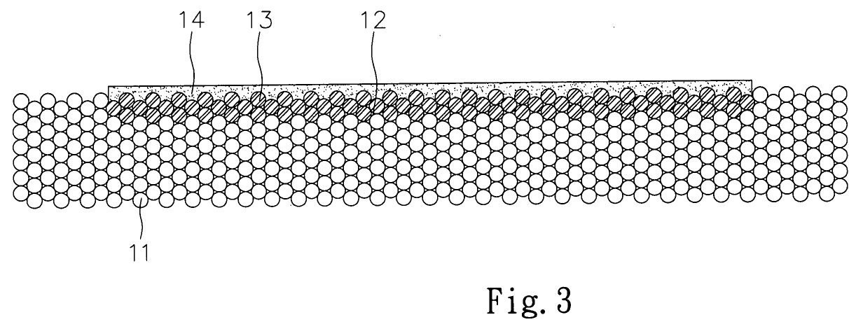

Referring to FIG. 3, a fabric 13 woven of polyester fibers is provided between each decorative strip 14 and the fabric 11. The polyester fibers of the fabrics 13 and the nylon fibers of the fabric 11 are woven together. As woven together, the fabrics 13 are secured to the fabric 11. Each decorative strip 14 can easily be attached to a fabric 13 by means of coating or thermal transfer. Without using thermal glue, the band 10 is durable in high temperatures that often happen during transportation.

The present invention has been described via detailed illustration of some embodiments. Those skilled in the art can derive variations from the embodiments without departing from the scope of the present invention. Therefore, the embodiments shall not limit the scope of the present invention defined in the claims.

1. A web comprising a first fabric of nylon fibers, a second fabric of polyester fibers woven together with the first fabric of nylon fibers and a decorative layer attached to the second fabric.

2. The web according to claim 1 wherein the decorative layer is attached to the second fabric by means of coating.

3. The web according to claim 1 wherein the decorative layer is attached to the second fabric by means of thermal transfer.
